(19) United States
(12) Patent Application Publication
(10) Pub. No.: US 2002/0087724 A1
(43) Pub. Date: Jul. 4, 2002

(54) Combining connections for parallel access to multiple frame relay and other private networks

(75) Inventors: Sanchaita Datta, Salt Lake City, UT (US); Ragula Bhaskar, Salt Lake City, UT (US)

Correspondence Address: JOHN W L OGILVIE, COMPUTER LAW, 1211 EAST YALE AVE, SALT LAKE CITY, UT, 84105, US

(73) Assignee: Ragula Systems d/b/a FatPipe Networks

(21) Appl. No.: 10/034,197

(22) Filed: Dec. 28, 2001

Related U.S. Application Data
(60) Provisional application No. 60/259,269, filed on Dec. 29, 2000.

(51) Int. Cl. G06F 15/173; H04L 12/28; H04L 12/56

(52) U.S. Cl. 709/241; 370/400

(57) ABSTRACT

Methods, configured storage media, and systems are provided for communications using two or more frame relay or point-to-point networks in parallel to provide load balancing across network connections, greater reliability, and/or increased security. A controller provides access to two or more private networks in parallel, through direct or indirect network interfaces. When one attached network fails, the failure is sensed by the controller and traffic is routed through one or more other private networks. When all attached networks are operating, the controller preferably balances the load between them.

### RELATED APPLICATIONS

This application claims priority to commonly owned copending U.S. provisional patent application Ser. No. 60/259,269 filed Dec. 29, 2000, which is also incorporated herein by reference.

### FIELD OF THE INVENTION

The present invention relates to computer network data transmission, and more particularly relates to tools and techniques for point-to-point or switched connection communications such as those using two or more frame relay networks in parallel to provide benefits such as load balancing across network connections, greater reliability, and increased security.

### TECHNICAL BACKGROUND OF THE INVENTION

Frame relay networking technology offers relatively high throughput and reliability. Data is sent in variable length frames, which are a type of packet. Each frame has an address that the frame relay network uses to determine the frame's destination. The frames travel to their destination through a series of switches in the frame relay network, which is sometimes called a network “cloud”; frame relay is an example of packetswitched networking technology. The transmission lines in the frame relay cloud must be essentially error-free for frame relay to perform well, although error handling by other mechanisms at the data source and destination can compensate to some extent for lower line reliability. Frame relay and/or point-to-point network services are provided or have been provided by various carriers, such as AT&T, Qwest, XO, and MCI WorldCom.

Frame relay networks are an example of a “private network”. Another example is a point-to-point network, such as a T1 or T3 connection. Although the underlying technologies differ somewhat, for purposes of the present invention frame relay networks and point-to-point networks are generally equivalent in important ways, such as the conventional reliance on manual switchovers when traffic must be redirected after a connection fails. A frame relay permanent virtual circuit is a virtual point-to-point connection. Frame relays are used as examples throughout this document, but the teachings will also be understood in the context of point-to-point networks.

A frame relay or point-to-point network may become suddenly unavailable for use. For instance, both MCI WorldCom and AT&T users have lost access to their respective frame relay networks during major outages. During each outage, the entire network failed. Loss of a particular line or node in a network is relatively easy to work around. But loss of an entire network creates much larger problems. Tools and techniques are needed to permit continued data transmission when the entire frame relay network that would normally carry the data is down.

FIG. 1 illustrates prior art configurations involving two frame relay networks for increased reliability; similar configurations involve one or more point-to-point network connections. Two sites 102 transmit data to each other (alternately, one site might be only a data source, while the other is only a data destination). Each site has two border routers 104. Two frame relay networks 106, 108 are available to the sites 102 through the routers 104. The two frame relay networks 106, 108 have been given separate numbers in the figure, even though each is a frame relay network, to emphasize the incompatibility of frame relay networks provided by different carriers. An AT&T frame relay network, for instance, is incompatible in many details with an MCI WorldCom frame relay network. For instance, two frame relay networks may have different maximum frame sizes or switching capacities. The two providers have to agree upon information rates, switching capacities, frame sizes, etc. before the two networks can communicate directly with each other.

A configuration like that shown in FIG. 1 may be actively and routinely using both frame relay networks A and B. For instance, a local area network (LAN) at site 1 may be set up to send all traffic from the accounting and sales departments to router Al and send all traffic from the engineering department to router B1. This may provide a very rough balance of the traffic load between the routers, but it does not attempt to balance router loads dynamically in response to actual traffic and thus is not “load-balancing” as that term is used herein.

Alternatively, one of the frame relay networks may be a backup which is used only when the other frame relay network becomes unavailable. In that case, it may take even skilled network administrators several hours to perform the steps needed to switch the traffic away from the failed network and onto the backup network. In general, the necessary Private Virtual Circuits (PVCs) must be established, routers at each site 102 must be reconfigured to use the correct serial links and PVCs, and LANs at each site 102 must be reconfigured to point at the correct router as the default gateway.

Although two private networks are shown in FIG. 1, three or more such networks could be employed, with similar considerations coming into play as to increased reliability, limits on load-balancing, the efforts needed to switch traffic when a network fails, and so on. Likewise, for clarity of illustration FIG. 1 shows only two sites, but three or more sites could communicate through one or more private networks.

FIG. 2 illustrates a prior art configuration in which data is normally sent between sites 102 over a private network 106. A failover box 202 at each site 102 can detect failure of the network 106 and, in response to such a failure, will send the data instead over an ISDN link 204 while the network 106 is down. Using an ISDN link 204 as a backup is relatively easier and less expensive than using another private network 106 as the backup, but generally provides lower throughput.

FIG. 3 illustrates prior art configurations involving two private networks for increased reliability, in the sense that some of the sites in a given government agency or other entity 302 can continue communicating even after one network goes down. For instance, if a frame relay network A goes down, sites 1, 2, and 3 will be unable to communicate with each other but sites 4, 5, and 6 will still be able to communicate amongst themselves through frame relay network B. Likewise, if network B goes down, sites 1, 2, and 3 will still be able to communicate through network A. Only if both networks go down at the same time would all sites be completely cut off. Like the FIG. 1 configurations, the FIG. 3 configuration uses two private networks. Unlike FIG. 1, however, there is no option for switching traffic to another private network when one network 106 goes down, although either or both of the networks in FIG. 3 could have an ISDN backup like that shown in FIG. 2. Note also that even when both private networks are up, sites 1, 2, and 3 communicate only among themselves; they are not connected to sites 4, 5, and 6.

FIG. 4 illustrates a prior art response to the incompatibility of frame relay networks of different carriers. A special “network-to-network interface” (NNI) 402 is used to reliably transmit data between the two frame relay networks A and B. NNIs are generally implemented in software at carrier offices. Note that the configuration in FIG. 4 does not provide additional reliability by using two frame relay networks 106, because those networks are in series rather than in parallel. If either of the frame relay networks A, B in the FIG. 4 configuration fails, there is no path between site 1 and site 2; adding the second frame relay network has not increased reliability. By contrast, FIG. 1 increases reliability by placing the frame relay networks in parallel, so that an alternate path is available if either (but not both) of the frame relay networks fails. Someone of skill in the art who was looking for ways to improve reliability by putting networks in parallel would probably not consider NNIs pertinent, because they are used for serial configurations rather than parallel ones, and adding networks in a serial manner does not improve reliability.

It would be an advancement in the art to provide another alternative for increasing reliability by configuring private networks in parallel, especially if other benefits are also provided. Such improvements are disclosed and claimed herein.

### BRIEF SUMMARY OF THE INVENTION

The present invention provides tools and techniques for accessing multiple independent frame relay networks and/or point-to-point (e.g., T1 or T3) network connections in a parallel network configuration. In some embodiments a controller according to the invention comprises a site interface connecting the controller to a site, at least two private network interfaces, and a packet path selector which selects between private network interfaces according to a specified criterion. The controller receives a packet through the site interface and sends the packet through the private network interface that was selected by the packet path selector. The controller's packet path selector selects between private network interfaces according to various criteria, such as (a) a load-balancing criterion that promotes balanced loads on devices that carry packets after the packets leave the selected private network interfaces; (b) a reliability criterion that promotes use of devices that will still carry packets after the packets leave the selected private network interfaces, when other devices that could have been selected are not functioning, and (c) a security criterion that promotes use of multiple private networks to carry different pieces of a given message so that unauthorized interception of packets on fewer than all of the networks used to carry the message will not provide the total content of the message. Some controller embodiments include only two private network interfaces, while others have three or more private network interfaces, each of which is selectable by the packet path selector. The private network interfaces may connect to a User-to-Network Interface, or they may comprise network-specific interface means of the type found in frame relay network routers.

One method of the invention for combining connections for access to multiple parallel frame relay and/or point-to-point networks, comprises the steps of: obtaining a controller, the controller comprising a site interface, at least two private network interfaces, and a packet path selector which selects between private network interfaces according to a specified criterion; connecting the controller site interface to a site to receive packets from a computer at the site; connecting a first private network interface of the controller to a first private network; connecting a second private network interface of the controller to a second private network which is parallel to and independent of the first private network; and sending a packet to the site interface which then sends the packet through a private network interface selected by the packet path selector. The criterion used by the packet path selector may be a load-balancing criterion, a reliability criterion, and/or a security criterion.

Another method for combining connections for access to multiple independent parallel frame relay or point-to-point networks comprises the steps of: sending a packet to a site interface of a controller, the controller comprising the site interface which receives packets, at least two private network interfaces, and a packet path selector which selects between private network interfaces according to a specified criterion; and specifying the criterion for use by the packet path selector, wherein the specified criterion is one of: a security criterion, a reliability criterion, a load-balancing criterion. In one variation, the step of sending a packet to the controller site interface is repeated as multiple packets are sent, the step of specifying a criterion specifies a security criterion, and the controller sends different packets of a given message to different frame relay networks.

Other features and advantages of the invention will become more fully apparent through the following description.

### BRIEF DESCRIPTION OF THE DRAWINGS

To illustrate the manner in which the advantages and features of the invention are obtained, a more particular description of the invention will be given with reference to the attached drawings. These drawings only illustrate selected aspects of the invention and its context. In the drawings:

FIG. 1 is a diagram illustrating a prior art approach having frame relay networks configured in parallel for increased reliability for all networked sites, in configurations that employ manual switchover between the two networks in case of failure.

FIG. 2 is a diagram illustrating a prior art approach having a frame relay network configured in parallel with an ISDN network link for increased reliability for all networked sites.

FIG. 3 is a diagram illustrating a prior art approach having independent frame relay networks, with each network connecting several sites but little or no communication between the networks.

FIG. 4 is a diagram illustrating a prior art approach having frame relay networks configured in series through a network-to-network interface, with no consequent increase in reliability because the networks are in series rather than in parallel.

FIG. 5 is a diagram illustrating generally configurations of the present invention, in which two or more private networks are placed in parallel for increased reliability for all networked sites, without requiring manual traffic switchover, and with the option in some embodiments of load balancing between the networks and/or increasing security by transmitting packets of a single logical connection over different private networks.

FIG. 6 is a diagram further illustrating the present invention, in which three sites can communicate over two parallel private networks.

FIG. 7 is a diagram further illustrating a multiple private network access controller of the present invention, which comprises a component tailored to each private network to which the controller connects, and a path selector in the controller which uses one or more of the following as criteria: private network status (up/down), private network load, use of a particular private network for previous packets in a given logical connection or session.

FIG. 8 is a flowchart illustrating methods of the present invention for sending packets over multiple parallel independent private networks for enhanced reliability, load balancing and/or security.

### DETAILED DESCRIPTION OF THE PREFERRED EMBODIMENTS

The present invention relates to methods, systems, and configured storage media for connecting sites over multiple independent parallel private networks such as frame relay networks and/or point-to-point network connections. “Multiple” networks means two or more such networks. “Independent” means routing information need not be shared between the networks. “Parallel” does not rule out the use of NNIs and serial networks, but it does require that at least two of the networks in the configuration be in parallel so that alternate data paths through different private networks are present. “Frame relay networks” or “private networks” does not rule out the use of an ISDN link or other backup for a particular frame relay or point-to-point private network, but it does require the presence of multiple such networks—FIG. 2, for instance, does not meet this requirement.

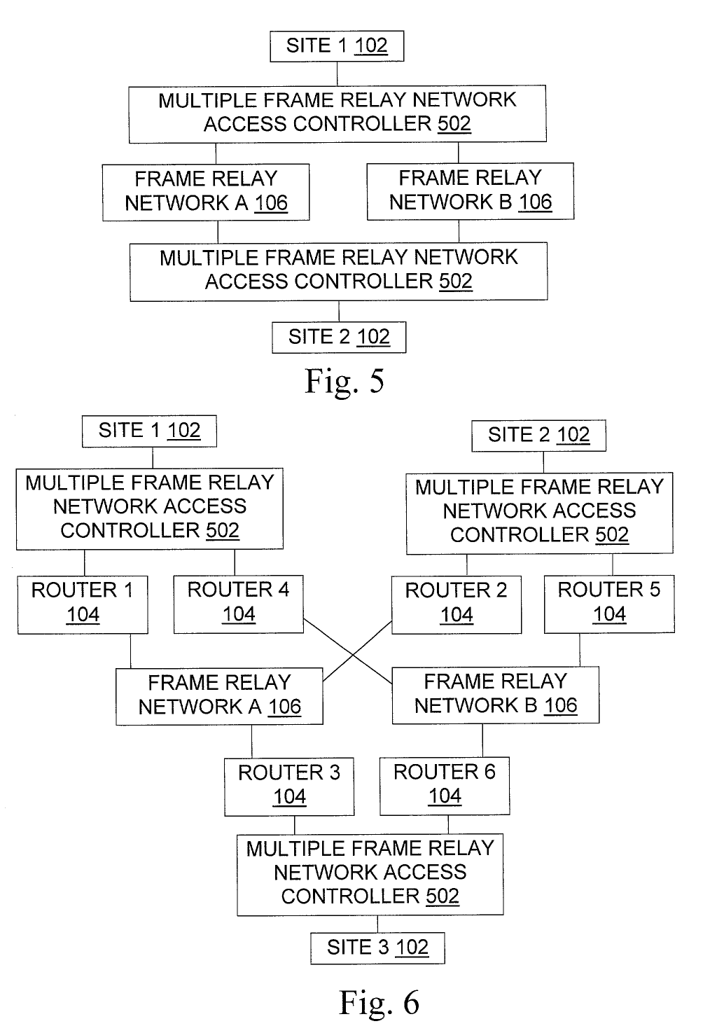

FIG. 5 illustrates generally configurations of the present invention involving frame relay networks; comments made here also apply to similar configurations involving point-to-point networks, or both types (frame relay and point-to-point) of private network. Two or more frame relay networks 106 are placed in parallel between two or more sites 102. Access to the frame relay networks 106 at each site is through an inventive controller 502. The system containing the controllers 502 provides point-to-point connectivity between the sites 102. Additional controllers 502 may be used at each location, to provide a switched connection system with no single point of failure.

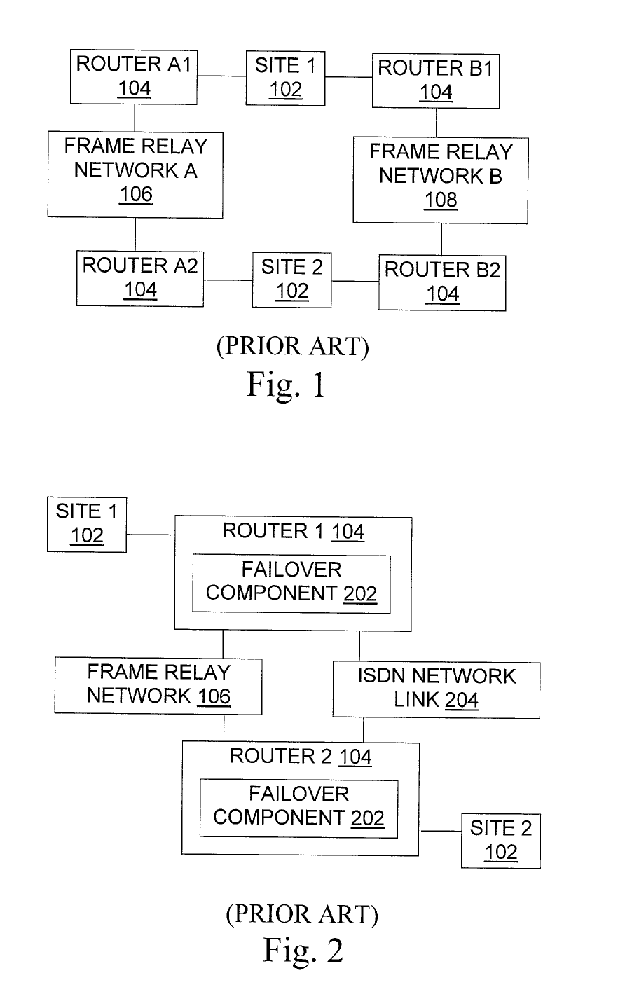

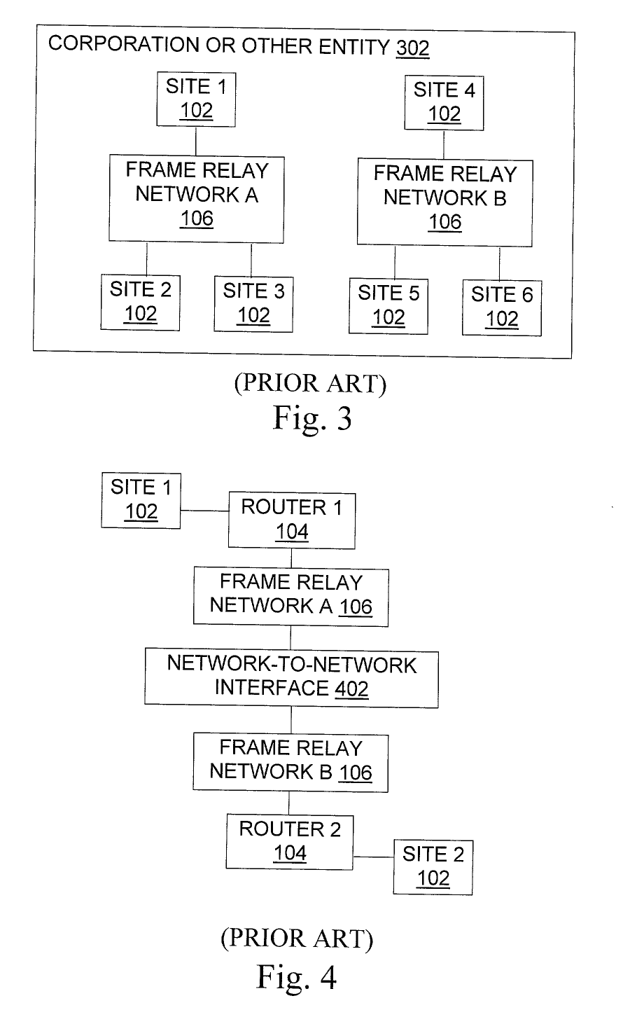

Unlike the configuration shown in FIG. 1, the inventive configuration in FIG. 5 does not require manual intervention by network administrators to coordinate traffic flow over the parallel networks 106. The networks 106 are independent of each other. When one attached network fails, the failure is sensed by the controller 502 and traffic is automatically routed through one or more other frame relay networks. Unlike the configuration in FIG. 2, the inventive configuration combines two or more frame relay networks 106. Unlike the configuration in FIG. 4, the inventive configuration requires two or more frame relay networks 106 be placed in parallel (although additional networks may also be placed in series). Unlike the configuration in FIG. 3, the inventive configuration does not merely partition sites between unconnected networks—with the invention, most or all of the connected sites get the benefit of parallel networks, so they can continue transceiving even if one of the networks goes down.

Another difference between the inventive approach and prior approaches may also be noted here, namely, the narrow focus of some prior art on reliability differs from the present document's broader view, which considers load balancing and security as well as reliability. Configurations like those shown in FIG. 2 are directed to reliability (which is also referred to by terms such as “fault tolerance”, “redundancy”, “backup”, “disaster recovery”, “continuity”, and “failover”). That is, one of the network paths (in this case, the one through the frame relay network) is the primary path, in that it is normally used for most or all of the traffic, while the other path (in this case, the one through the ISDN link) is used only when that primary path fails. Although the inventive configurations can be used in a similar manner, with one frame relay network being on a primary path and the other network(s) being used only as a backup when that first network fails, the inventive configurations also permit concurrent use of two or more frame relay networks. With concurrent use, elements such as load balancing between frame relay networks, and increased security by means of splitting pieces of a given message between frame relay networks, which are not considerations in the prior art of FIG. 2, become possibilities in some embodiments of the present invention.

In general, the different frame relay or other private networks 106 will be provided by different carriers (WorldCom, AT&T, Qwest, etc.). In such cases, each frame relay network 106 typically operates on its own distinct clock. In some embodiments, the controller 502 sends traffic over all frame relay networks 106 to which it is connected, for load balancing and/or enhanced security. In other embodiments or situations, the controller 502 prefers a particular network 106, and uses the other network(s) as backup in case the preferred network 106 becomes unavailable.

In some embodiments, a frame relay network C at a location 3 is connected to a controller 502 for a location 1 but is not necessarily connected to the controller 502 at another location 2. In such cases, a packet from location 3 addressed to location 2 can be sent over network C to the controller at location 1, which can then redirect the packet to location 2 by sending it over network A or network B. That is, controllers 502 are preferably, but not necessarily, provided at every location that can send packets over the parallel independent networks 106 of the system.

In some embodiments, the controller 502 at the receiving end of the network connection between two sites A and B has the ability to re-sequence the packets. This means that if the lines are of dissimilar speeds or if required by security criteria, the system can send packets out of order and re-sequence them at the other end. Packets may be sent out of sequence to enhance security, to facilitate load-balancing, or both. The TCP/IP packet format includes space for a sequence number, which can be used to determine proper packet sequence at the receiving end (the embodiments are dual-ended, with a controller 502 at the sending end and another controller 502 at the receiving end). The sequence number (and possibly more of the packet as well) can be encrypted at the sending end and then decrypted at the receiving end, for enhanced security.

FIG. 6 further illustrates the present invention, in a particular configuration in which three sites 102 can communicate over two parallel independent frame relay networks 106; two or more point-to-point networks could be used similarly, as could a mixture of frame relay and point-to-point networks. In one such configuration, sites 1, 2, and 3 are connected via frame relay clouds 106. Routers 1, 2, and 3 are connected to frame relay cloud A, and routers 4, 5, and 6 are connected to frame relay cloud B. The WAN ports of the routers 104 on each frame cloud 106 are configured to form a single subnet. Virtual circuits (VCs) exist between site 1 and site 2, between site 2 and site 3, and between site 3 and site 1, on each of the clouds 106. A controller 502 is connected to each pair of routers 104 at each location to provide at least reliability through redundancy.

In operation, the controller 502 on each location is provided with a configuration file or other data structure containing a list of all the LAN IP addresses of the controllers 502 at the locations, and their subnet masks. Each controller 502 keeps track of available and active connections to the remote sites 102. If any of the routes are unavailable, the controller 502 preferably detects and identifies them. When a controller 502 receives IP traffic to any of the distant networks, the data is sent on the active connection to that destination. If all connections are active and available, the data load is preferably balanced across all the routers 104. If any of the VCs (or point-to-point connections) are unavailable, or any of the routers 104 are down, the traffic is not forwarded to that router; when the routes become available again, the load balancing across all active routes preferably resumes.

In some embodiments, load balancing is not the only factor considered when the controller 502 determines which router 104 should receive a given packet. Security may be enhanced by sending packets of a given message over two or more networks 106. Even if a packet sniffer or other eavesdropping tool is used to illicitly obtain data packets from a given network 106, the eavesdropper will thus obtain at most an incomplete copy of the message because the rest of the message traveled over a different network 106. Security can be further enhanced by sending packets out of sequence, particularly if the sequence numbers are encrypted.

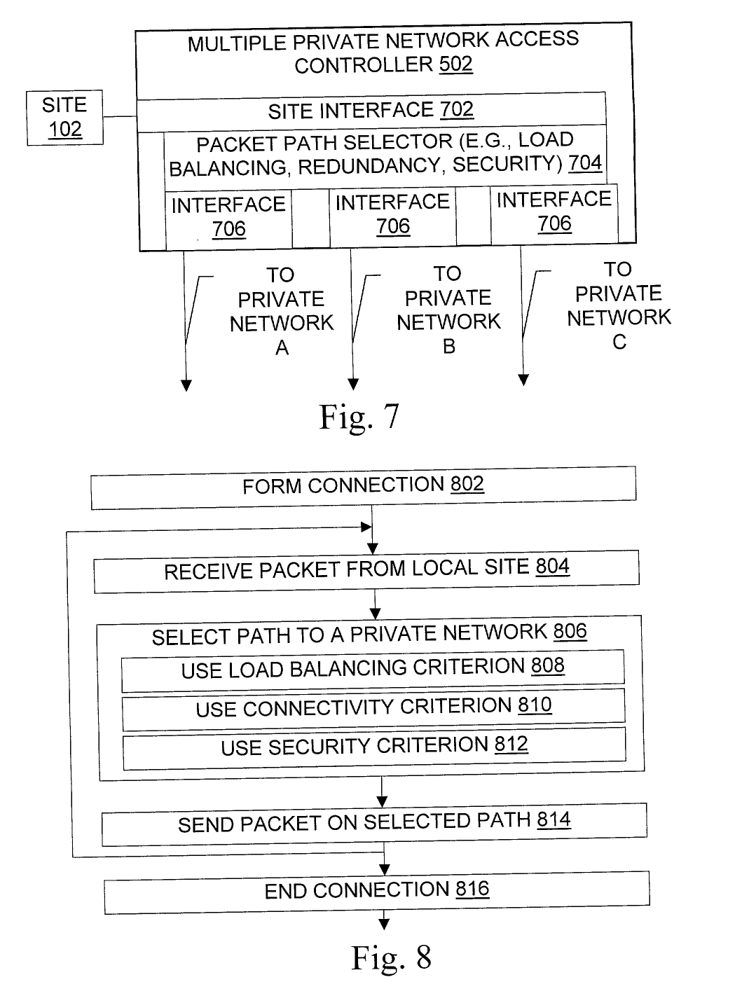

FIG. 7 is a diagram further illustrating a multiple frame relay and/or point-to point network access controller 502 of the present invention. A site interface 702 connects the controller 502 to the LAN at the site 102. This interface 702 can be implemented, for instance, as any local area network interface, like 10/100Base-T ethernet, gigabit ATM or any other legacy or new LAN technology.

The controller 502 also includes a packet path selector 704, which may implemented in custom hardware, or implemented as software configuring semi-custom or general-purpose hardware. The path selector 704 determines which path to send a given packet on. In the configuration of FIG. 6, for instance, the path selector in the controller at location I selects between a path through router 1 and a path through router 4. In different embodiments and/or different situations, one or more of the following criteria may be used to select a path for a given packet, for a given set of packets, and/or lo for packets during a particular time period:

Redundancy: do not send the packet(s) to a path through a network 106, a router 104, or a connection that is apparently down. Instead, use devices (routers, network switches, bridges, etc.) that will still carry packets after the packets leave the selected network interfaces, when other devices that could have been selected are not functioning. Techniques and tools for detecting network path failures are generally well understood, although their application in the context of the present invention is believed to be new.

Load-balancing: send packets in distributions that balance the load of a given network, router, or connection relative to other networks, routers, or connections available to the controller 502. This promotes balanced loads on one or more of the devices (routers, frame relay switches) that carry packets after the packets leave the selected network interfaces. Load-balancing may be done through an algorithm as simple as a modified round-robin approach which places the next packet on the next available line, or it may involve more complex algorithms that attempt to measure and track the throughput, latency, and/or other performance characteristics of a given link or path element. Load-balancing is preferably done on a per-line basis, as opposed to prior art approaches which use a per-department and/or per-router basis for dividing traffic. Load-balancing algorithms in general are well understood, although their application in the context of the present invention is believed to be new.

Security: divide the packets of a given message (session, file, web page, etc.) so they travel over different networks 106. This promotes the use of multiple frame relay networks to carry different pieces of a given message, so that unauthorized interception of packets on fewer than all of the networks used to carry the message will not provide the total content of the message. Dividing message packets between networks 106 for better security may be done in conjunction with load balancing, and may in some cases be a side-effect of load-balancing. But load-balancing can be done on a larger granularity scale than security, e.g., by sending one entire message over network A and the next entire message over network B. Security may thus involve finer granularity than load balancing, and may even be contrary to load balancing in the sense that dividing up a message to enhance security may increase the load on a heavily loaded path even though a more lightly loaded alternate path is available and would be used for the entire message if security was not sought by message-splitting between networks. Other security criteria may also be used, e.g., one network 106 may be viewed as more secure than another, encryption may be enabled, or other security measures may be taken.

The controller 502 also includes two or more private network interfaces 706, namely, so there is at least one interface 706 per private network 106 to which the controller 502 controls access. Each interface 706 can be implemented as a direct interface 706 or as an indirect interface 706; a given embodiment may comprise only direct interfaces 706, may comprise only indirect interfaces 706, or may comprise at least one of each type of interface. A direct interface 706 may be implemented, for instance, as a direct frame relay connection over land line or wireless or network interfaces to which the frame relay routers can connect, or as a point-to-point interface to a dedicated Ti, T3, or wireless connection. One suitable implementation includes a standard Ethernet card, which connects to an external frame relay User-Network Interface (UNI) in a router of a network 106. UNIs generally are known in the art. One indirect interface 706 effectively makes part of the controller 502 into a UNI by including in the interface 706 the same kind of special purpose hardware and software that is found on the frame relay network side (as opposed to the UNI side) of a frame relay network router. Such an indirect frame relay network interface 706 is tailored to the specific timing and other requirements of the frame relay network to which the indirect interface 706 connects. For instance, one indirect interface 706 may be tailored to a Qwest frame relay network 106, while another indirect interface 706 in the same controller 502 is tailored to a UUNet network 106. The indirect interface 706 may connect to the frame relay network 106 over fiber optic, T1, wireless, or other links. In short, a direct interface 706 relies on special purpose hardware and connectivity/driver software in a router, to which the direct interface 706 of the controller 502 connects through a UNI. By contrast, an indirect interface 706 includes such special purpose hardware and connectivity/driver software inside the controller 502 itself. In either case, the controller provides packet switching capabilities for at least redundancy without manual switchover, and preferably for dynamic load-balancing between lines as well. The controller 502 in each case also optionally includes memory buffers in the site interface 702, in the path selector 704, and/or in the network interfaces 706.

An understanding of methods of the invention will follow from understanding the invention's devices, and vice versa. For instance, from FIGS. 5-7, one may ascertain methods of the invention for combining connections for access to multiple parallel private networks 106, such as frame relay networks. One method begins by obtaining a controller 502. The controller comprises (a) a site interface 702, (b) at least two network interfaces 706 tailored to particular frame relay networks 106 for operation as though part of a network-to-network interface in a serial network configuration, and (c) a packet path selector 704 which selects between network interfaces 706 according to a specified criterion. Path selection criteria may be specified by configuration files, hardware jacks or switches, ROM values, remote network management tools, or other means. One then connects the site interface 702 to a site 102 to receive packets from a computer (possibly via a LAN) at the site 102. Likewise, one connects a first network interface 706 to a first router 104 for routing packets to a first frame relay network 106, and a second network interface 706 to a second router 104 for routing packets to a second frame relay network 106. A third, fourth, etc. frame relay network 106 may be similarly connected to the controller 502 in some embodiments and/or situations. The connected frame relay networks 106 are parallel to one another (not serial, although additional networks not directly connected to the controller 502 may be serially connected to the networks 106). The connected frame relay networks 106 are independent of one another, in that no routing information need be shared between them, to make them parallel (NNIs can still be used to connect networks in serial to form a larger independent and parallel network). A mistake in the routing information for one network 106 will thus not affect the other network 106. After the connections are made (which may be done in a different order than recited here), one sends a packet to the site interface 702, which then sends the packet through the one (or more—copies can be sent through multiple networks 106) network interface 706 that was selected by the packet path selector 704.

FIG. 8 is a flowchart further illustrating methods of the present invention, which send packets over multiple parallel independent private networks 106 for enhanced reliability, load balancing and/or security; frame relay networks are used as an example, but point-to-point networks may be similarly employed. During a connection forming step 802, at least one virtual circuit is obtained between two sites 102. If the frame relay networks 106 will be used concurrently, the controllers 502 provide a connection which comprises multiple conventional virtual circuits, since two or more networks may (or will) carry packets during the step 802 connection. The controller 502 then checks the status of each connection and updates the information for available communication paths.

During a packet receiving step 804, the controller 502 at a given location receives a packet to be sent from that location to another site 102. In some cases, multiple packets may be received in a burst. The packet comes into the controller 502 through the site interface 702.

During a path selecting step 806, the path selector 704 selects the path over which the packet will be sent; selection is made between at least two paths, each of which goes over a different network 106 than the other. The networks 106 are independent parallel frame relay networks. This path selecting step 806 may be performed once per packet, or a given selection may pertain to multiple packets. Path selection 806 is shown as following packet receipt 804, but in some embodiments and/or some situations, it may precede packet receipt 804. More generally, the steps illustrated and discussed in this document may be performed in various orders, including concurrently, except in those cases in which the results of one step are required as input to another step. Likewise, steps may be omitted unless required by the claims, regardless of whether they are expressly described as optional in this Detailed Description. Steps may also be repeated, or combined, or named differently.

As indicated, the path selection may use 808 load balancing as a criterion for selecting a path, use 810 network 106 status (up/down) and other connectivity criteria (e.g., router status, connectivity status) as a criterion for selecting a path, and/or use 812 division of packets between networks 106 for enhanced security as a criterion for selecting a path. These steps may be implemented in a manner consistent with the description above of the path selector 704 given in the discussion of FIG. 7. More generally, unless it is otherwise indicated, the description herein of systems of the present invention extends to corresponding methods, and vice versa.

The description of systems and methods likewise extend to corresponding computer-readable media (e.g., RAM, ROM, other memory chips, disks, tape, lomega ZIP or other removable media, and the like) which are configured by virtue of containing software to perform an inventive method, or software (including any data structure) which is uniquely suited to facilitate performance of an inventive method. Articles of manufacture within the scope of the present invention thus include a computer-readable storage medium in combination with the specific physical configuration of a substrate of the computer-readable storage medium, when that substrate configuration represents data and/or instructions which cause one or more computers to operate in a specific and predefined manner as described and claimed herein.

During a packet transmission step 814, the packet is sent on the selected 806 path. This is done by sending the packet over the network interface 706 for the path selected. As indicated in FIG. 8, the method may then loop back to receive 804 the next packet, select 806 its path, send 814 it, and so on. As noted, other specific method instances are also possible. One example is the inventive method in which load balancing or reliability criteria cause an initial path selection to be made 806, and then a loop occurs in which multiple packets are received 804 and then sent 814 over the selected path without repeating the selecting step 806 for each receive 804-send 814 pair. Note that some embodiments of the invention permit packets of a given message to be sent over different networks 106, thereby enhancing 812 security. The PVCs are in general always connected, but an ending step 816 may be performed during an orderly shutdown for diagnostic or upgrade work, for instance.

### SUMMARY

The present invention provides methods and devices for placing frame relay and other private networks in parallel, thereby providing redundancy without requiring manual switchover in the event of a network failure. Load-balancing between lines and/or between networks may also be performed. For instance, the invention can be used to provide reliable, efficient, and secure point-to-point connections for private networks 102. Some prior art approaches require network reconfiguration each time a frame relay circuit fails, and some have complex router configurations to handle load balancing and network failures. This requires substantial effort by individual frame relay network customers to maintain connectivity, and they will often receive little or no help from the frame relay carriers. Instead, well-trained staff are needed at each location, as are expensive routers. By contrast, these requirements are not imposed by the present invention.

As used herein, terms such as “a” and “the” and item designations such as “connection” or “network” are generally inclusive of one or more of the indicated item. In particular, in the claims a reference to an item normally means at least one such item is required.

The invention may be embodied in other specific forms without departing from its essential characteristics. The described embodiments are to be considered in all respects only as illustrative and not restrictive. Headings are for convenience only. The scope of the invention is, therefore, indicated by the appended claims rather than by the foregoing description. All changes which come within the meaning and range of equivalency of the claims are to be embraced within their scope.

What is claimed and desired to be secured by patent is:

1. A controller which controls access to multiple independent private networks in a parallel network configuration, the controller comprising:
a site interface connecting the controller to a site;
at least two private network interfaces; and
a packet path selector which selects between private network interfaces according to a specified criterion;
wherein the controller receives a packet through the site interface and sends the packet through the private network interface that was selected by the packet path selector.

2. The controller of claim 1, wherein the controller control access to multiple independent frame relay networks, and each of the at least two private network interfaces comprises a frame relay network interface.

3. The controller of claim 1, wherein the packet path selector selects between private network interfaces according to a load-balancing criterion, thereby promoting balanced loads on devices that carry packets after the packets leave the selected private network interfaces.

4. The controller of claim 1, wherein the packet path selector selects between private network interfaces according to a reliability criterion, thereby promoting use of devices that will still carry packets after the packets leave the selected private network interfaces, when other devices that could have been selected are not functioning.

5. The controller of claim 1, wherein the packet path selector selects between private network interfaces according to a security criterion, thereby promoting use of multiple private networks to carry different pieces of a given message so that unauthorized interception of packets on fewer than all of the private networks used to carry the message will not provide the total content of the message.

6. The controller of claim 1, wherein the controller sends packets out of sequence over the parallel private networks.

7. The controller of claim 6, wherein the controller places an encrypted sequence number in at least some of the packets which are sent out of sequence.

8. The controller of claim 1, wherein the controller comprises at least three frame relay network interfaces, each of which is selectable by the packet path selector.

9. The controller of claim 1, wherein the controller operates in a system providing at least one point-to-point connection.

10. The controller of claim 1, wherein the controller operates in a system providing connectivity over at least two frame relay networks from at least two carriers, each frame relay network operating on its own clock which is different from the clock of the other frame relay network.

11. The controller of claim 1, wherein each private network interface is an indirect interface tailored to a particular type of frame relay network.

12. The controller of claim 1, wherein each private network interface is a direct interface comprising an Ethernet card.

13. A method for combining connections for access to multiple parallel private networks, the method comprising the steps of:
obtaining a controller, the controller comprising a site interface, at least two private network interfaces, and a packet path selector which selects between private network interfaces according to a specified criterion;
connecting the controller site interface to a site to receive packets from a computer at the site;
connecting a first private network interface of the controller to a first private network,
connecting a second private network interface of the controller to a second private network which is parallel to and independent of the first private network; and
sending a packet to the site interface which then sends the packet through a private network interface selected by the packet path selector.

14. The method of claim 13, wherein the private networks are frame relay networks.

15. The method of claim 13, further comprising the step of specifying the criterion for use by the packet path selector, wherein the specified criterion is a load-balancing criterion.

16. The method of claim 13, further comprising the step of specifying the criterion for use by the packet path selector, wherein the specified criterion is a reliability criterion.

17. The method of claim 13, further comprising the step of specifying the criterion for use by the packet path selector, wherein the specified criterion is a security criterion.

18. The method of claim 13, wherein at least one of the steps connecting a private network interface of the controller connects the controller to a User-to-Network Interface in a router of a frame relay network.

19. A method for combining connections for access to multiple independent parallel frame relay networks, the method comprising the steps of:
sending a packet to a site interface of a controller, the controller comprising the site interface which receives packets, at least two network interfaces, and a packet path selector which selects between network interfaces according to a specified criterion; and
specifying the criterion for use by the packet path selector, wherein the specified criterion is one of: a security criterion, a reliability criterion, a load-balancing criterion.

20. The method of claim 19, wherein the step of sending a packet to the controller site interface is repeated as multiple packets are sent, the step of specifying a criterion specifies a security criterion, and the controller sends different packets of a given message to different frame relay networks.

21. The method of claim 19, further comprising the step of sensing failure of one of the parallel frame relay networks and automatically sending traffic through at least one other parallel frame relay network.
